(19) United States
(12) Patent Application Publication
(10) Pub. No.: US 2022/0246906 A1
(43) Pub. Date: Aug. 4, 2022

(54) ELECTRIC ENERGY STORAGE DEVICE & METHOD

(71) Applicant: INSTITUTT FOR ENERGITEKNIKK, Kjeller (NO)

(72) Inventors: Alexey KOPOSOV, Oslo (NO); Jan Petter MÆHLEN, Frogner (NO); Asbjørn ULVESTAD, Oslo (NO)

(21) Appl. No.: 17/621,731

(22) PCT Filed: Jun. 24, 2020
(86) PCT No.: PCT/EP2020/067587

§ 371 Date: Dec. 22, 2021

(30) Foreign Application Priority Data
Jun. 24, 2019 (NO) 20190791

(51) Int. Cl. H01M 4/134; H01M 10/0525; H01M 4/133; H01M 4/1393; H01M 4/1395

(52) U.S. Cl. CPC H01M 4/134; H01M 10/0525; H01M 4/1395; H01M 4/1393; H01M 4/133

(57) ABSTRACT

Electrical energy storage device (22) comprising an anode (24), a cathode (26) and electrolyte (28), whereby the anode (24) comprises particles (10, 20, 30, 40) comprising an amorphous and/or crystalline silicon-based core (12), a continuous or non-continuous first carbon-containing shell (14, 14a), and a continuous or non-continuous second carbon-containing shell (16, 16a). The second carbon-containing shell (16, 16a) has a higher density and/or a higher atomic percentage of carbon than the first carbon-containing shell (14, 16a).

### TECHNICAL FIELD

The present invention concerns an electric energy storage device, such as a lithium or sodium ion battery, comprising an anode, a cathode and electrolyte, whereby the anode comprises multi-shell particles. The present invention also concerns a method for producing multi-shell particles for an anode of an electrical energy storage device.

### BACKGROUND OF THE INVENTION

Electrochemical batteries for energy storage can be produced in many ways. Currently, the battery chemistry which has been seeing the fastest growth is the lithium-ion battery. The key elements of this technology are the electrodes: anode and cathode, the electrolyte enabling the ion migration between the two electrodes inside the battery, the separator providing spacing between the electrodes and the current collectors providing the external electrical connection. During charge and discharge of the battery, depending on current flow, lithium ions travel through the electrolyte either from the cathode to the anode or in the opposite direction. To preserve the overall electric charge of the battery, electrical current is established from the current collectors to balance the transport of the positively charged lithium-ion transport.

An electrode usually takes the shape of a film comprising the active material that interacts with lithium and participates in the electrochemical process, a binder ensuring the adhesion of the active material to the electrode and mechanical integrity of the electrode, and often a conductive additive, such as graphite, to provide extra electrical conductivity within the electrode. Such film is typically produced through a solution-based process, such as preparation and deposition of slurry, comprised of abovementioned components. For simplicity of electrode fabrication, the active material is typically introduced into processing steps in the form of a powder. The particle nature of the active material is preserved through all steps necessary for the battery fabrication.

Silicon, in general, is considered to be a very promising anode material for lithium-ion batteries due to its very high theoretical lithium absorption capacity of up to 4.4 lithium atoms per one silicon atom. However, silicon in its pure form suffers from structural degradations resulting in performance losses and ultimate battery failure due to constant expansion and contraction driven by lithiation/delithiation. Silicon expands by up to 400% during the absorption of lithium, meaning that for each cycle of charging, the silicon will expand during lithium uptake; and then contract through the discharge of the battery during lithium departure. Both processes take place in different parts of the same electrode often at different rates. This process can cause cracking or fracture of the silicon particles, which exposes new surfaces of the active material for interactions with the electrolyte and reduces the internal electron conductivity of the particles to the extent that some parts of the particle can become disconnected from the conductive network of the battery electrode. In addition to the reported cracking/fracturing, it has been reported that silicon, that was fully lithiated/delithiated, reorganizes itself into new structures according to the lithium flows during lithiation and delithiation of the electrodes. Such process was named as silicon migration. All the processes mentioned above continuously expose new surfaces of the active material to the electrolyte during the battery function, and after long cycling, the surface to volume ratio of the silicon can rise to extreme values, which not only increase the electrical resistance of the anode, but also consumes lithium ions and electrolyte necessary for the battery functionality.

When embedded in a battery, specifically during anode function, an active material surface will chemically react with electrolyte, lithium and electrolyte additives to produce a solid-electrolyte-interphase (SEI) layer. This process also consumes lithium dissolved in the electrolyte. For silicon, during further cycling of the battery, this layer has been known to peel off from the silicon surface (due to expansion and contraction), thereby exposing a clean surface of silicon in addition to the processes described above. This freshly exposed surface will participate in forming a new SEI layer. In addition, the degradation mechanisms described above (damage of particles and silicon migration) will lead to very large surface areas with SEI layer formation and will correspondingly result in a large amount of electrolyte being degraded. This can lead to degradation and complete failure of the battery after 20-150 cycles depending on the nature of anode material.

A possible solution to the suppression of the structural degradation processes is to utilize nanoparticles of silicon material. Such an approach still allows solution-based processing of the anode materials, when silicon nanoparticles are mixed together with additives (often carbon-based materials) and organic binders. The carbon-based materials (examples include graphite, graphene, carbon nanotubes, etc.) are needed to achieve the necessary electronic conductivity of the anode, while the binder materials are used to interconnect the silicon nanoparticles in the anode formulation of the slurry. Proper selection of the silicon nanoparticles, and other components of the formulation results in an extension of the lifetime of the anode and helps to prevent some of the intrinsic degradation mechanisms of the silicon material.

As an alternative to using pure silicon, a number of prior art documents propose other silicon-based materials to mitigate the failure mechanisms of the anode. Such materials include non-stoichiometric silicon oxide, carbide and nitride. Similarly, non-stoichiometric silicon phosphide has also been proposed. Generally, the use of such materials allows for the formation of small particles of silicon embedded in a matrix material comprised of lithium, silicon and oxygen and/or nitrogen, depending on the material selection. Such silicon-based materials are also often utilized in the form of nanoparticles, which allows for the traditional processing of anodes through slurry deposition.

Some prior art documents and studies have addressed the degradation problems outlined above by coating the silicon with organic or inorganic materials. The shell, which in most cases refers to a continuous and conformal coverage of particle/nanoparticle with another material, can be applied using a variety of methods, could physically minimize the particles' expansion, and/or delivers the opportunity of permanent contact of other electrode components with silicon material even upon its fracturing. Furthermore, being conductive, the coating provides additional electrical contact to the active material. In addition, such shells often serve as artificial SEI layer minimizing the consumption of lithium and electrolyte, thus extending the battery lifetime. Inorganic shells, which are usually applied using Atomic Layer Deposition (ALD) or solution-based chemistry, often provide good electric and ionic conductivity. However, the majority of inorganic shells do not have the elasticity that is ideally required for the expansion of the silicon structure to take a full advantage of its capacity. This may result in damage of the shell due to the particle and shell fracturing, which leads to similar degradation mechanisms as for pure silicon although such shells will delay battery failure. If a shell does not undergo fracturing, it may provide substantially better stability of the anode at the cost of the limited capacity, as a robust inorganic shell will limit the expansion of the silicon and therefore the lithium intake.

A carbon-based shell is often prepared by mechanical coating of silicon with graphite and graphene. The latter potentially delivers flexibility to the whole structure allowing complete expansion during lithiation while preserving the continuity of shell. The mechanical coating technique typically refers to the process of planetary ball-milling, where silicon particles are milled together with the carbon source. Alternative milling processes could be also utilized for such coating. Other carbon-based shells often involve the formation of a carbon layer after a required additional carbonization step which is usually performed by mixing silicon particles into a polymer and heating the mixture in an inert atmosphere. At high temperature the polymer decomposes forming a carbon/silicon composite.

US patent application no. US 2015/280222 discloses that the expansion of silicon will break most coatings applied thereto, leading to fresh silicon surfaces being exposed. The high mobility of lithiated silicon will then lead to this fresh surface dominating further lithiation, and thereby degradation behavior. Sometimes, it is attempted to mitigate the cracking by only partially lithiating an electrode, but this can lead to inhomogeneous lithiation as some particles experience high local resistance and are not lithiated as intended, while other particles are fully lithiated and thereby degrade more rapidly.

The article entitled “A Yolk-Shell Design for Stabilized and Scalable Li-Ion Battery Alloy Anodes” by Nian Liu, Hui Wu, Matthew T. McDowell, Yan Yao, Chongmin Wang, and Yi Cui‡, Nano Lett., 2012, 12 (6), pp 3315-3321 describes the preparation of a yolk-shell structure to provide a silicon electrode having a high capacity, long cycle life, high efficiency, and whose fabrication is industrially scalable. The fabrication is carried out without special equipment and mostly at room temperature although it requires a high temperature annealing step and HF treatment. Commercially available silicon nanoparticles are completely sealed inside conformal, thin, self-supporting carbon shells, with a rationally designed void space in between the particles and the shell. The well-defined void space allows the silicon particles to expand freely without breaking the outer carbon shell, therefore stabilizing the solid-electrolyte interphase on the shell surface. High capacity, however at low cycling rate, (˜2800 mAh/g at C/10), long cycle life (1000 cycles with 74% capacity retention), and high Coulombic efficiency (99.84%) have been realized in this yolk-shell structured silicon electrode. A major disadvantage of such yolk-shell structure is that its synthesis requires complex multi-step chemistry which involves coating the silicon nanoparticles with SiO₂ and then with carbon, and later etching with hydrofluoric acid. The complexity of the processing significantly restricts the scaling up and therefore limits the practical application of this approach.

Chinese patent application no. CN 106941170A discloses a silicon-carbon negative electrode material. The silicon-carbon negative electrode material comprises a core structure and a shell structure. A buffer layer is arranged between the core structure and the shell structure. The buffer layer is tightly connected to the surface of the core structure. The buffer layer is tightly connected to the inner surface of the shell structure. The buffer layer has a porous structure with porosity of 1% to 80%. The core structure and the shell structure are tightly connected by the buffer layer so that in the whole cycle, the core structure and shell structure of the silicon-carbon negative electrode material are closely linked together.

Despite the efforts and the major improvements delivered through the use of silicon-based materials and nanoparticles thereof, the issues associated with the degradation of silicon-based anodes still remain.

### SUMMARY OF THE INVENTION

The present invention aims to provide an improved electrical energy storage device comprising an anode, a cathode and electrolyte, whereby the anode comprises multi-shell particles. The electrical energy storage device is, for example, a lithium-ion battery which mitigates at least one of the degradation processes described above. Similar principles could be applied to the batteries based on alternative chemistries, such as sodium-ion.

This aim is achieved by an electrical energy storage device comprising the features recited in claim 1. The electrical energy storage device namely includes an anode that comprises multi-shell particles which have an amorphous or crystalline silicon-based core, a continuous or non-continuous first carbon-containing shell, and a continuous or non-continuous second carbon-containing shell, whereby, the second carbon-containing shell has a higher density and/or a higher atomic percentage of carbon than the first carbon-containing shell.

According to an embodiment of the invention, the particles comprising an amorphous and/or crystalline silicon-based core are individual silicon particles, whereby each individual silicon particle comprises a continuous or non-continuous first carbon-containing shell and a continuous or non-continuous second carbon-containing shell, whereby the second carbon-containing shell has a higher density and/or a higher atomic percentage of carbon than the first carbon-containing shell. Alternatively, the particles comprising an amorphous and/or crystalline silicon-based core are aggregates of two or more individual silicon particles, whereby each aggregate of silicon particles comprises a continuous or non-continuous first carbon-containing shell and a continuous or non-continuous second carbon-containing shell, whereby the second carbon-containing shell has a higher density and/or a higher atomic percentage of carbon than the first carbon-containing shell.

According to an embodiment of the invention, the multi-shell particles comprise an annealed first carbon-containing shell and an annealed second carbon-containing shell, i.e. the particles are annealed (i.e. carbonized) before they are incorporated into the anode of the electrical energy storage device. Alternatively, the multi-shell particles comprise a non-annealed (non-carbonized) first carbon-containing shell and a non-annealed second carbon-containing shell, whereby the multi-shell particles are not annealed (non-carbonized) before they are incorporated into the anode of the electrical energy storage device.

According to an embodiment of the invention the silicon-based core comprises one of the following: pure silicon (Si) or silicon-based containing one or more other elements, modified or non-modified, amorphous or crystalline, stoichiometric or non-stochiometric silicon nitride (SiNₓ) or silicon carbide (SiCₓ), or silicon oxide (SiOₓ), or a material comprising at least 20 atomic-% of silicon. The silicon-based core may be entirely amorphous, or entirely crystalline, or a combination of amorphous or crystalline phases. The silicon-based core may contain at least one of the following elements: boron (B), carbon (C), nitrogen (N), oxygen (O), sulphur (S), phosphorus (P), selenium (Se), arsenic (As), tin (Sn), magnesium (Mg), aluminium (Al), iron (Fe), germanium (Ge), antimony (Sb) or hydrogen (H). By modifying the silicon-based core, both the electron mobility and the lithium mobility can be improved. In addition, such core modification can be optimized to give the right band bending in the interface between a particle and an SEI-layer, so that no tunneling barrier is introduced.

According to an embodiment of the invention the silicon-based core comprises silicon nitride that has a chemical formula of SiNₓ where 0.2≤x<1.3. The silicon-based core namely comprises silicon and nitrogen in the ratio 1:x and optionally other elements.

According to an embodiment of the invention the particles comprise a stoichiometric or non-stoichiometric silicon oxide shell either naturally formed through exposure to air or though annealing of the particles in the oxygen-containing atmosphere.

According to an embodiment of the invention the particles comprise a silicon-based core, with a diameter of 20 nm-2 μm for spherical particles, or a minimum transverse dimension of 20 nm-2 μm for non-spherical particles.

According to an embodiment of the invention, multi-shell particles are obtained by coating the silicon-based core completely or partially with the first and second carbon-containing materials.

According to an embodiment of the invention, in addition to the annealed or non-annealed first carbon-containing shell and the second annealed or non-annealed carbon-containing shell, the multi-shell structure may comprise at least one additional continuous or non-continuous annealed or non-annealed shell.

According to an embodiment of the invention the first carbon-containing shell and the second carbon-containing shell after annealing (carbonization) each have a maximum thickness of up to 100 nm.

According to an embodiment of the invention the first carbon-containing shell and the second carbon-containing shell before annealing each have a maximum thickness of up to 500 nm.

According to an embodiment of the invention the silicon-based core particles are aggregated silicon-based core particles.

According to an embodiment of the invention the particles comprise agglomerates of particles according to any of the embodiments of the invention covered by a third continuous or non-continuous, annealed or non-annealed carbon-containing shell.

According to an embodiment of the invention the third carbon-containing shell has a maximum average thickness of 500 nm.

According to an embodiment of the invention the first carbon-containing material or the second carbon-containing material comprises at least one of the following: a synthetic or natural polymer or copolymer (linear, branched or cross-linked), such as a saturated and unsaturated hydrocarbon-based polymer (such as polyethylene and similar), a polymer based on a carbohydrate material, a sugar-based polymer, an aromatic hydrocarbon polymer (such as substituted or non-substituted polystyrene), an aromatic residue from petroleum, a chemical process pitch, a lignin-based polymer, a phenolic-based polymer (products of condensation of substituted or non-substituted phenols with carbonyl compounds, such phenol-formaldehyde), methacrylate-based polymers (such as polymethyl methacrylate or its analogs), polyethers, polyesters, halogen-containing polymers (such as polyvinyl chloride) or a polymer containing one or more heteroatoms, nitrogen (N), oxygen (O) or phosphorus (P), such as polyacrylonitrile or a combination of thereof.

The present invention also concerns a method for producing particles comprising an amorphous or crystalline silicon-based core for an anode of an electrical energy storage device. The method comprises the steps of: continuously or non-continuously coating silicon-based core particles with a first carbon-containing material to form a first continuous or non-continuous non-annealed carbon-containing shell, and then continuously or non-continuously coating the particles comprising a silicon-based core and the first carbon-containing shell with a second carbon-containing material to form a second continuous or non-continuous non-annealed carbon-containing shell, whereby the second carbon-containing material has a higher carbon content than the first carbon material thereby creating a first carbon-containing shell and a second carbon-containing shell, whereby the second carbon-containing shell has a higher density and/or a higher atomic percentage of carbon than the first carbon-containing shell. The first carbon-containing material and the second carbon-material must therefore be selected so that the second carbon-containing shell will have a higher density and/or a higher atomic percentage of carbon than the first carbon-containing shell.

According to an embodiment of the invention the method comprises the step of annealing (or carbonization) the coated particles to thereby create silicon-based core particles with an annealed first carbon-containing shell and an annealed second carbon-containing shell, whereby the second annealed carbon-containing shell has a higher density and/or a higher atomic percentage of carbon than the first annealed carbon-containing shell. In addition to carbonization of the carbon-containing material complete or partial crystallization (with or without formation of separate phases) of the silicon-based core may occur. Alternatively, the method does not comprise the step of annealing the coated particles, whereby the coated particles comprise a non-annealed first carbon-containing shell and a non-annealed second carbon-containing shell.

According to an embodiment of the invention the method comprises the step of annealing the particles comprising a silicon-based core, a first carbon-containing shell and a second carbon-containing shell by heating them to a temperature of 500-1500° C. in an oxygen-free atmosphere to produce silicon-based core with the first annealed carbon-containing shell of a low density and second annealed carbon-containing shell of a high density. Annealing of the particles comprising a silicon-based core, a first carbon-containing shell and a second carbon-containing shell results in the creation of particles comprising a silicon-based core, an annealed first carbon-containing shell and an annealed second carbon-containing shell, whereby the annealed second carbon-containing shell is connected to the silicon-based core via carbon fibres, i.e. the carbon fibres extend between the silicon-based core and the annealed second carbon-containing shell and serve as a first annealed carbon-containing shell.

According to an embodiment of the invention the first carbon-containing material and/or the second carbon-containing material is/are applied using a solution-based technique.

According to an embodiment of the invention the silicon-based core particles are embedded in one of the following: graphite, an organic or inorganic polymeric material so as to form an anode active material suitable for an electrical energy storage device.

According to an embodiment of the invention the solution-based technique comprises mixing the silicon-based core particles with a solution of the first carbon-containing material and/or mixing the particles comprising a silicon-based core coated in the first carbon-containing material with a solution of the second carbon-containing material.

According to an embodiment of the invention the first carbon-containing material is applied by performing polymerization in the presence of the silicon-based core particles.

According to an embodiment of the invention the second carbon-containing material is applied by performing polymerization in the presence of the particles comprising a silicon-based core and the first carbon-containing shell.

According to an embodiment of the invention the first carbon-containing material and/or the second carbon-containing material is/are applied to the entire surface area of the silicon-based core particles and/or to the entire surface area of the particles comprising a silicon-based core and the first carbon-containing material respectively, whereby the first carbon-containing material and/or the second carbon-containing material and consequently the subsequently created first carbon-containing shell and second carbon-containing shell provide continuous coverage of the particles' surface.

Alternatively, according to an embodiment of the invention, the first carbon-containing material and/or the second carbon-containing material is/are applied to one or more parts of a surface area of the silicon-based core particles and/or to at least one part of a surface area of the particles comprising a silicon-based core and the first carbon-containing material respectively, whereby the first carbon-containing material and/or the second carbon-containing material, and consequently the subsequently created first carbon-containing shell and second carbon-containing shell provide non-continuous coverage of the particles' surface.

According to an embodiment of the invention the method comprises the step of coating the particles comprising a silicon-based core, a first carbon-containing shell and a second carbon-containing shell, with one or more additional continuous or non-continuous shells before the step of creating a first annealed carbon-containing shell and a second annealed carbon-containing shell. Alternatively, a carbon-containing shell may be created each time a carbon-containing material is applied, for example each carbon-containing material may be annealed separately before an additional carbon-containing material is applied and then annealed.

According to an embodiment of the invention the first carbon-containing shell may be chemically bound to the surface of the silicon-based core. Additionally, the second carbon-containing shell may be chemically bound to the first carbon-containing shell.

According to an embodiment of the invention the first annealed carbon-containing shell may be chemically bound to the surface of the silicon-based core through either silicon-carbon bond or silicon-heteroatom bond. Additionally, the second annealed carbon-containing shell may be chemically bound to the first annealed carbon-containing shell.

According to an embodiment of the invention the anode for an electrical energy storage device, in addition to the active material described in the other embodiments of the invention, comprises at least one conductive additive and/or at least one binder material. A conductive additive is typically represented by carbon-based material; the examples of such may include hard carbon, graphite or graphene.

According to an embodiment of the invention the method comprises the step of embedding the silicon-based core particles in one of the following: graphite, an organic or inorganic polymeric material to form an anode of an electrical energy storage device.

The electrical energy storage device according to the present invention may be a lithium-ion battery.

The electrical energy storage device according to the present invention may be a sodium-ion battery.

According to an embodiment of the invention, the lithium-ion battery comprises an anode based on the particles according to any of the embodiments of the present invention, a cathode, an electrolyte and optionally, a separator.

### BRIEF DESCRIPTION OF THE DRAWINGS

The present invention will hereinafter be further explained by means of non-limiting examples with reference to the appended schematic figures where;

FIG. 1 schematically shows a cross section of a particle according to an embodiment of the invention before annealing,

FIG. 2 schematically shows a cross section of a particle according to an embodiment of the invention after annealing,

FIGS. 3-5 schematically show cross sections of particles after heat treatment according to various embodiments of the invention,

FIG. 6 schematically shows an electrical energy storage device according to an embodiment of the invention, and

FIG. 7 is a flow chart showing the steps of a method according to an embodiment of the invention.

It should be noted that the drawings have not necessarily been drawn to scale and that the dimensions of certain features may have been exaggerated for the sake of clarity.

Furthermore, any feature described with reference to one embodiment of the invention may be applied to any other embodiment of the invention as long as the description does not explicitly exclude this possibility.

### Definitions

An electrical energy storage device is any apparatus used for storing electrical energy that utilizes a reduction/oxidation reaction to convert electrical energy into chemical energy during charging and, conversely, chemical energy to electrical energy during discharging.

The electrode of an electrical energy storage device comprises a current collector which is usually constituted by a metal foil, such as a copper foil or an aluminum foil, and an electrode active material layer coated on a surface of the current collector. An electrode is the final product after a modified electrode active material has been applied to a current collector and dried and is ready for battery assembly

Of the electrodes in an electrochemical system, an anode is defined as an electrode on which an oxidation reaction happens, while a cathode is defined as an electrode on which a reduction reaction happens. For an electrochemical cell, the designations of the two electrodes change depending on whether the cell is charged or discharged; however, normal convention in battery technology is to designate the electrodes based on their function during discharge, as is used in the context of this document.

A current collector is used as an electron transfer channel for electrons formed in the electrochemical reactions of the electrical energy storage device to an external circuit to provide current. A current collector may also be called a “substrate”.

A binder is a material or substance that holds other materials together to form a cohesive whole by mechanical or chemical means. In a battery this entails holding the electrode material particles together, as well as holding this to the current collector.

Conductive additives are materials that are added to the electrodes to improve and maintain the electrical conductivity within the electrode, ensuring the necessary electrical connection between the active material particles and the current collector for the battery to function.

An active material in the context of the present document is a material that is directly involved in the electrochemical reaction itself, which results in energy release or storage. This is in contrast to passive materials which play a secondary role in the functioning of the device, e.g. binder and conductive additives, whose primary roles are to maintain the mechanical and electrical integrity of the electrodes, respectively.

A stoichiometric compound, sometimes called a daltonide, is any chemical compound in which the numbers of atoms of the elements present in the compound can be expressed as a ratio of small whole numbers, e.g. Si₃N₄. Conversely, a non-stoichiometric compound, sometimes called berthollide, is any compound where this is not the case, either denoted as a deviation from a common stoichiometric compound, e.g. Si₃N₄₋ₓ, or as a simple ratio, e.g. SiNₓ. Non-stoichiometric compounds where this ratio is smaller or greater than the common stoichiometric ratio could be also called sub-stoichiometric or super-stoichiometric compounds, respectively.

An amorphous material is a solid material in which the positions of the atoms do not exhibit the property of long-range order, often termed translational periodicity, in contrast to a crystalline solid in which atomic positions exhibit this property.

The term “modified” as used in this document refers to small atomic percentages of one or more modifying elements, namely up to 1 atomic percent. The silicon core of the particles according to the present invention may however contain silicon containing up to 80, up to 70, up to 60, up to 50, up to 40, up to 30 or up to 20 atomic percent of one or more other elements, such as one or more of the above-mentioned elements.

Aggregate, in the context of this document, relates to particles that themselves are comprised of a number of smaller particles bound together by chemical or mechanical means, together forming a whole.

A nanomaterial is a natural, incidental or manufactured material containing particles, in an unbound state or as an aggregate or as an agglomerate and where, for 50% or more of the particles in the number size distribution, one or more external dimensions is in the size range 1 nm-100 nm.

The Solid Electrolyte Interphase (SEI) is a passivating layer that forms on the surface of electrode materials as a consequence of electrolyte constituents decomposing at electrochemical potentials present at the electrodes. The layer consists primarily of electrolyte decomposition products and play a vital role in the stable operation of primarily Li-ion batteries.

An alloy is a substance composed of an intimate homogenous mix of two or more elements wherein one or more is a metal. The components of alloys cannot be separated using a physical means. In the context of the present document this term is used to describe silicon-based materials, as non-metal alloys or composites.

A current collector is used as an electron transfer channel for electrons formed in the electrochemical reactions of the electrical energy storage device to an external circuit to provide current. A current collector may also be called a “substrate”.

Carbonization is a process of converting carbon-containing materials into carbon. Typically performed in the absence of air or oxygen.

Annealing in the context of the present document referrers to a process of heating the material below its melting point.

### DETAILED DESCRIPTION OF EMBODIMENTS

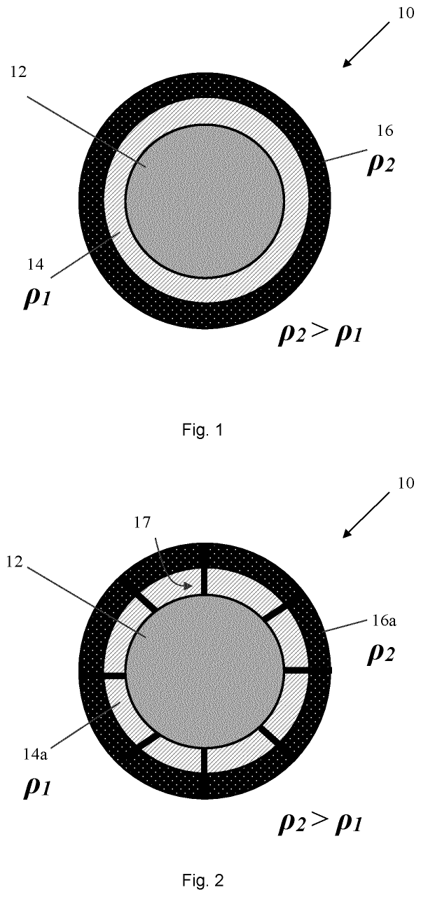

FIG. 1 shows a cross section of a particle 10 comprising an amorphous or crystalline silicon-based core 12, a non-annealed first continuous carbon-containing shell 14, having a density ρ₁, and a non-annealed second continuous carbon-containing shell 16, having a density ρ₂ according to an embodiment of the invention. The second carbon-containing shell 16 has a higher density than the first carbon-containing shell 14, i.e. ρ₂ is greater than ρ₁. In the illustrated embodiment the first carbon-containing shell 14 and the second carbon-containing shell 16 each have a maximum thickness of up to 100 nm. The particle 10, which is spherical, has a diameter of 20 nm-2 μm.

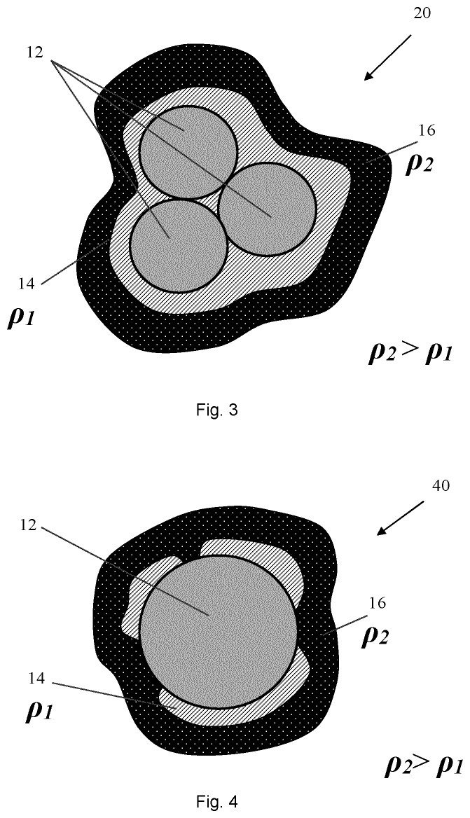

FIG. 2 shows the particle 10 illustrated in FIG. 1 after it has been annealed whereby the particle 10 comprises an annealed first continuous carbon-containing shell 14a and an annealed second continuous carbon-containing shell 16a. The annealing results in carbon fibres 17 forming within one or more carbon-containing shells, i.e. between the silicon-based core 12 and the second continuous carbon-containing shell 16a in the illustrated embodiment. It should be noted that the carbon fibres 17 may have a uniform or non-uniform distribution within a carbon-containing shell and do not necessarily extend in a straight line or direct line as illustrated schematically in FIG. 2. Furthermore, carbon fibres 17 alone can constitute a carbon-containing shell, i.e. an inner carbon-containing shell may be constituted by a lower density porous carbon layer, or carbon fibres attaching an outer carbon-containing shell to the silicon-based core 12, or a combination of both a lower density porous carbon layer and carbon fibres 17.

A silicon-based core 12 may be connected to the outside surface of a particle 10 by carbon fibres 17. Such a structure is suitable for the creation of silicon-based materials for lithium-ion battery anodes, where the migration of silicon will be limited. The presence of carbon fibres 17 allows the silicon-based core 12 to be in constant contact with the active material despite fracturing. Furthermore, the carbon fibres 17 will improve the conductivity of an anode formed using particles 10 of this kind.

A first carbon-containing shell 14, 14a of a particle according to the present invention may either have the same chemical composition or a different chemical composition as the second carbon-containing shell 16, 16a. The first carbon-containing shell 14, 14a and the second carbon-containing shell 16, 16a may have different properties. For example, a first carbon-containing shell 14a (if created using a carbon-containing material such as a sugar-based polymer) will be in the form of a porous or fibre-based residue. A second carbon-containing shell 16a (if created using a carbon-containing material such as polystyrene) will be in the form of a more compact dense carbon layer.

The silicon-based core 12 can comprise one of the following: pure silicon (Si) or silicon-based material containing one or more other elements, modified or non-modified, crystalline of amorphous, stoichiometric or non-stochiometric silicon nitride (SiNₓ) or silicon carbide (SiCₓ) or silicon oxide (SiOx), or a material comprising at least 20 atomic-% of silicon. The silicon-based core may for example contain at least one of the following elements: boron (B), carbon (C), nitrogen (N), oxygen (O), sulphur (S), phosphorus (P), selenium (Se), arsenic (As), tin (Sn), magnesium (Mg), aluminium (Al), iron (Fe), germanium (Ge), antimony (Sb) or hydrogen (H). By modifying the silicon-based core or adding one or more elements thereto, both the electron mobility and the lithium mobility of an electrical energy storage device containing such particles can be improved. In addition, the modifying elements or element addition(s) can be optimized to give the right band bending in the interface between a particle and solid-electrolyte-interphase (SEI) layer, so that no tunneling barrier is introduced.

The particles 10 may for example be used to produce an anode for a lithium-ion battery. By using silicon nitride instead of carbon anodes in lithium-ion batteries, or at least replacing part of the carbon with silicon nitride, it has been shown that the storage capacity of the battery can be substantially increased.

According to an embodiment of the invention the chemical composition of the silicon-based core 12 is represented by the chemical formula SiNₓ where 0.2≤x<1.2, 0.2≤x<1.1, or where 0.4≤x<1.0 or where 0.6≤x<0.9. It has been found that SiNₓ with x<0.2 shows excellent lithium-absorption capacity, but suffers from degradation, with a Coulombic efficiency of less than 99%. The degradation is slower than for pure silicon, but still too large for most commercial applications. The value of x is tuned to the lithium-absorption capacity desired for a particular application, such as for an anode in which a trade-off between the conductivity of the particles, the lithium absorption capacity of the particles, the expansion of the particles and the first cycle irreversible capacity of the particles needs has to be reached.

The benefit to the total battery capacity obtained by increasing the anode capacity depends heavily on the cathode capacity. Better cathodes see greater benefits from improved anodes. Thus, the commercial benefit of increasing battery capacity will have to be considered in each individual case.

The initial lithiation of silicon nitride will leave lithium trapped both in certain states in the bulk of the material, and at the surface of the particles 10. Increasing particle size will allow a reduction of the irreversible capacity related to the surface reaction. The bulk trapping of lithium is directly related to the amount of nitrogen in the silicon-based core particles 12, and by reducing the nitrogen content therein, first cycle irreversible capacity is reduced, while the cyclable capacity is increased.

Apart from US patent application no. US 2015/280222, there seem to be very few, if any, prior art documents that specify any advantages of using amorphous silicon in the silicon-based core particles 12 rather than crystalline silicon. The advantage of amorphous silicon is that there is a multitude of diffusion paths available, and the clear two-phase behaviour seen in lithiation of crystalline silicon is removed.

Since Si₃N₄ is an insulator it can be difficult to achieve the initial lithiation of silicon nitride-based core particles 12 when these particles are to be used in a lithium-ion battery for example. Three innovations are proposed by the inventors to mitigate this. Firstly, it is suggested to keep the concentration of nitrogen low, i.e. lower than the atomic concentration of silicon, to improve conductivity and lithium uptake. Secondly, it is proposed that the silicon nitride-based core particles 12 should have an amorphous structure to improve lithiation homogeneity and reduce the stresses in the silicon nitride-based core particles 12 during lithiation. Thirdly, it is proposed to form a first carbon-containing shell 14, 14a and a second carbon-containing shell 16, 16a on the silicon nitride-based core particles 12 where the electrochemical transition from Li↔Li++e− can occur outside the silicon nitride-based core particles 12 before the lithium atom diffuses into the silicon nitride-based core particles 12, reducing the importance of the electric conductivity of the nitride.

According to an embodiment of the invention the particles 10 comprise a metal, such as lithium. Pre-lithiating particles 12 will improve battery performance if the particles 12 are used in a battery, such as a lithium-ion battery. Including lithium in the particles 12 before submersing the particles in electrolyte is namely advantageous since it reduces irreversible lithium consumption during initial battery cycles and reduces the need for time-consuming battery cycling for stabilization in a factory to obtain an equilibrium condition prior to the use of the battery.

Furthermore, since lithium silicon alloys are initially usually amorphous, the amorphous nature of particles 10 is likely to speed up the kinetics of lithiation. It is more difficult for cracks to propagate through amorphous material, and the internal strain between different regions of the particles 10 with different lithium contents will be lower if all areas are amorphous, or at least microcrystalline or nanocrystalline.

According to an embodiment of the invention the method comprises the step of adding lithium to the silicon nitride-based core particles 12 so that the particles have a lithium content in the range of 0 to 350 atomic-percent. According to an embodiment of the invention the lithium content matches the irreversible bulk capacity of the material, for example the lithium content is in the range of 0-50 atomic-% or 0-30 atomic-%.

Large quantities of high purity amorphous or crystalline silicon-based core particles 12 having a narrow size distribution (i.e. substantially monodisperse) may be produced using chemical vapour deposition (CVD), Atomic Layer Deposition (ALD) or a plasma-assisted method for example. The silicon-based core particles 12 produced in this way will have a smooth surface that is free from irregularities, roughness and projections when viewed at a maximum resolution of a Scanning Electron Microscope (SEM), i.e. a spatial resolution less than 100 nm. Additionally, since the method results in the production of particles having a spherical or substantially spherical shape, the handling of the silicon-based core particles 12 is facilitated.

The density of a carbon-containing shell may be determined using any suitable method. However, using a second carbon-containing material that has a higher carbon content first carbon-containing material will result in the created second carbon-containing shell 16 having a higher density than the first carbon-containing shell 14 prior to the annealing step. Subsequently, upon annealing (carbonization) this will result in the created annealed second carbon-containing shell 16a, having a higher density and or amount of carbon than the first annealed carbon-containing shell 14a.

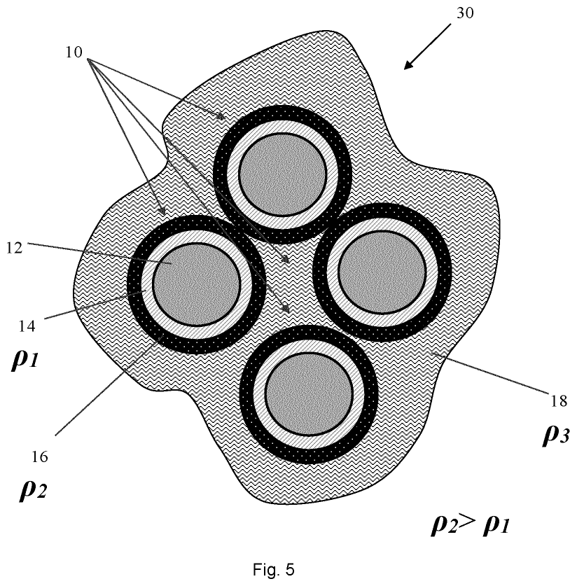

FIG. 3 shows the cross section of a particle 20 comprising aggregated silicon-based core particles 12, a first non-annealed continuous carbon-containing shell 14 having a density ρ₁, and a second non-annealed continuous carbon-containing shell 16 having a density ρ₂ according to an embodiment of the invention. The second carbon-containing shell has a higher density than the first carbon-containing shell, i.e. ρ₂ is greater than ρ₁.

FIG. 4 shows a cross-section of a particle 40 comprising an amorphous or crystalline silicon-based core 12, a first non-continuous non-annealed carbon-containing shell 14 having a density ρ₁, and a second continuous non-annealed carbon-containing shell 16 having a density ρ₂ according to an embodiment of the invention. The second carbon-containing shell 16 has a higher density than the first carbon-containing shell 14, i.e. ρ₂ is greater than ρ₁. In the illustrated embodiment the first carbon-containing shell 14 and the second carbon-containing shell 14 each have a maximum thickness of up to 100 nm. The particle 10, which is non-spherical, has a minimum transverse dimension of 20 nm-2 μm. It should be noted that either or both of the first carbon-containing shell 14 and/or the second carbon-containing shell 16 can be non-continuous.

FIG. 5 shows the cross section of particles 30 comprising an agglomerate of the particles 10 shown in FIG. 3 which comprise an amorphous or crystalline silicon-based core 12, a first continuous non-annealed carbon-containing shell 14 having a density ρ₁, and a second continuous non-annealed carbon-containing shell 16 having a density ρ₂ according to an embodiment of the invention. The second carbon-containing shell 16 has a higher density than the first carbon-containing shell 14, i.e. ρ₂ is greater than ρ₁. The agglomerate of the particles 10 are coated by a third carbon-containing shell 18, which can be a carbon-containing shell having a density ρ₃, whereby ρ₃>ρ₂>ρ₁ for example Alternatively, ρ₃ can be lower than ρ₂ and/or ρ₁. Having a third carbon-containing shell 18 that is less dense than the first carbon-containing shell 14 and/or the second carbon-containing shell 16 can facilitate faster transport and higher flexibility. The third carbon-containing shell 18 may have a maximum average thickness of 500 nm, measured radially outwards along a line from the centre of the particle 30 from the surface of a particle 10 that constitutes part of the agglomerate of particle 10 to the outside surface of the particle 30.

The particles shown in FIGS. 2-5 may be used to produce an anode for an electrical energy storage device. A mixture of two or more different types of particles may be used to produce an anode for an electrical storage device.

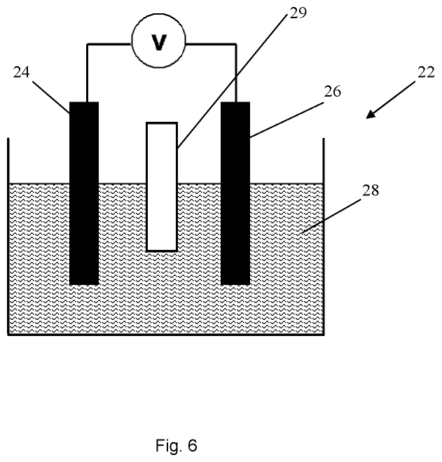

FIG. 6 shows an electrical energy storage device, 22, namely a battery, comprising an anode 24 comprising multi-shell particles according to any of the embodiments described herein. The illustrated electrical energy storage device 22 also comprises a cathode 26, an electrolyte 28 and a separator 29.

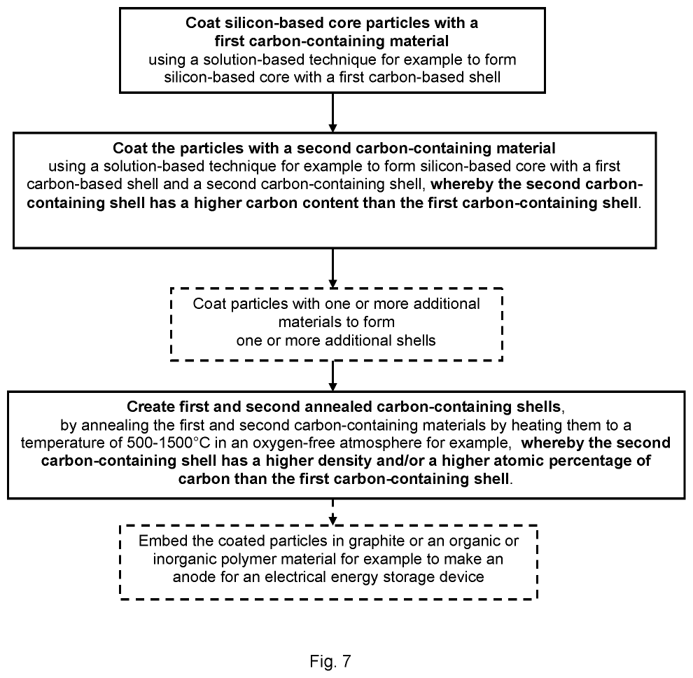

FIG. 7 shows the steps of a method for producing particles comprising an amorphous or crystalline silicon-based core according to any of the embodiments of the present invention. The method comprises the steps of: combining the silicon-based core particles 12 with a first carbon-containing material forming a silicon-based core with a first carbon-containing shell, and then combining the particles comprising a silicon-based core 12 and the first carbon-containing shell with a second carbon-containing material forming silicon-based core with a first carbon-containing shell and a second carbon-containing shell, whereby the second carbon-containing shell has a higher carbon content than the first carbon shell. The method then comprises the step of creating an annealed first carbon-containing shell 14a and an annealed second carbon-containing shell 16a, whereby the second carbon-containing shell 16a has a higher density than the first carbon-containing shell 14a. The carbon content of a carbon material can be measured using any suitable method, such as mass spectrometry, XPS or EELS.

According to an embodiment of the invention the first carbon-containing material and/or the second carbon-containing material is/are applied to the entire surface area of the silicon-based core particles and/or to the entire surface area of the particles comprising a silicon-based core and the first carbon-containing material respectively, whereby the first carbon-containing material and/or the second carbon-containing material and consequently the subsequently created first carbon-containing shell 14a and second carbon-containing shell 16a provide continuous coverage of the particles' surface.

According to an alternative embodiment of the invention the first carbon-containing material and/or the second carbon-containing material may be applied to one or more parts of a surface area of the silicon-based core particles 12 and/or to at least one part of a surface area of the particles comprising a silicon-based core 12 and the first carbon-containing material respectively, whereby the first carbon-containing material and/or the second carbon-containing material, and consequently the subsequently created first carbon-containing shell 14a and second carbon-containing shell 16a provide non-continuous coverage of the particles' surface.

The first carbon-containing material and/or the second carbon-containing material may be applied using a solution-based technique. For example, the solution-based technique comprises mixing the silicon-based core particles 12 with a solution of the first carbon-containing material and/or mixing the particles comprising a silicon-based core 12 coated with the first carbon-containing material with a solution of the second carbon-containing material.

Alternatively, the first carbon-containing material and/or the second carbon-containing material may be applied by performing polymerization in the presence of the silicon-based core particles 12 or the particles comprising a silicon-based core and the first carbon-containing material.

According to an embodiment of the invention the method comprises the step of annealing the particles comprising a silicon-based core, a first carbon-containing material and a second carbon-containing material by heating them to a temperature of 500-1500° C., such as 600° C., in an oxygen-free atmosphere, such as in argon or any other inert atmosphere, so as to avoid oxidation, to produce the first carbon-containing shell and second first carbon-containing shell. Optionally, the particles may be coated with one or more additional materials before or after the step of creating a first carbon-containing shell and a second carbon-containing shell.

According to an embodiment of the invention the first carbon-containing material and/or the second carbon-containing shells is/are created by annealing at least one of the following: a synthetic or natural polymer or copolymer (linear, branched or cross-linked), such as a saturated and unsaturated hydrocarbon-based polymer (such as polyethylene and similar), a polymer based on a carbohydrate material, a sugar-based polymer, an aromatic hydrocarbon polymer (such as substituted or non-substituted polystyrene), an aromatic residue from petroleum, a chemical process pitch, a lignin-based polymer, a phenolic-based polymer (products of condensation of substituted or non-substituted phenols with carbonyl compounds, such phenol-formaldehyde), methacrylate-based polymers (such as polymethyl methacrylate or its analogues), polyethers, polyesters, halogen-containing polymers (such as polyvinyl chloride) or a polymer containing one or more heteroatoms, nitrogen (N), oxygen (O) or phosphorus (P), such as polyacrylonitrile or a combination of thereof.

According to an embodiment of the invention the method comprises the step of coating the particles comprising a silicon-based core 12, a first carbon-containing shell 14 and a second carbon-containing shell 16, with one or more additional continuous or non-continuous materials before the step before of creating a first carbon-containing shell 14a and a second carbon-containing shell 16a.

According to an embodiment of the invention said particles 10, 20, 30, 40 may be embedded in one of the following: graphite, an organic or inorganic polymeric material to produce an anode. Alternatively, an anode may be fabricated using slurry-based processing, where the particles 10, 20, 30, 40 are mixed with a binder and an additional conductive additive.

According to an embodiment of the invention the particles 10, 20, 30, 40 may be used in a lithium ion battery comprising an electrolyte additive that enhances the first cycle lithiation of the particles 10, 20, 30, 40, by providing a surface electrolyte interface layer that facilitates the lithiation of the particles 10, 20, 30, 40. According to an embodiment of the invention the electrolyte additive is at least one of the following: FEC (Fluoroethylene Carbonate), Vinylene Carbonate (VC).

Further modifications of the invention within the scope of the claims would be apparent to a skilled person.

1. Electrical energy storage device (22) comprising an anode (24), a cathode (26), separator and electrolyte (28), characterized in that said anode (24) comprises particles (10, 20, 30, 40) comprising an amorphous and/or crystalline silicon-based core (12), a continuous or non-continuous first carbon-containing shell (14), and a continuous or non-continuous second carbon-containing shell (16), whereby, said second carbon-containing shell (16) has a higher density and/or a higher atomic percentage of carbon than said first carbon-containing shell (14).

2. Electrical energy storage device (22) according to claim 1, characterized in that said particles (10, 20, 30, 40) comprise an annealed first carbon-containing shell (14a), and an annealed second carbon-containing shell (16a).

3. Electrical energy storage device (22) according to claim 1, characterized in that said first carbon-containing shell (14), and/or said second carbon-containing shell (16) are non-annealed.

4. Electrical energy storage device (22) according to any of the preceding claims, characterized in that said silicon-based core (12) comprises one of the following: pure silicon (Si) or silicon containing one or more other elements, modified or non-modified, stoichiometric or non-stochiometric silicon nitride (SiNₓ) or silicon carbide (SiCₓ), or silicon oxide (SiOₓ), or a material comprising at least 20 atomic-% of silicon.

5. Electrical energy storage device (22) according to any of the preceding claims, characterized in that said modified silicon-based core (12) is modified with at least one of the following modifying elements: phosphorus (P), boron (B), carbon (C), nitrogen (N), oxygen (O), sulphur (S), selenium (Se), arsenic (As), tin (Sn), magnesium (Mg), aluminium (Al), iron (Fe), germanium (Ge), antimony (Sb) or hydrogen (H).

6. Electrical energy storage device (22) according to any of the preceding claims, characterized in that said first carbon-containing shell (14, 14a) and said second carbon-containing shell (16, 16a) comprise at least one additional continuous or non-continuous annealed or non-annealed shell.

7. Electrical energy storage device (22) according to any of the preceding claims, characterized in that said first carbon-containing shell (14, 14a) and said second carbon-containing shell (16, 16a) each have a maximum thickness of up to 100 nm.

8. Electrical energy storage device (22) according to any of the preceding claims, characterized in that said particles (10, 20, 30, 40) comprise a silicon-based core (12), with a diameter of 20 nm-2 μm for spherical particles, or a minimum transverse dimension of 20 nm-2 μm for non-spherical particles.

9. Electrical energy storage device (22) according to any of claims 1-7, characterized in that said silicon-based core particles (12) are aggregated silicon-based core particles (12).

10. Electrical energy storage device (22) according to claim 9, characterized in that said silicon-based core particles (12) comprise agglomerates of particles (10, 20, 30, 40) according to any of claims 1-7 covered by a third continuous or non-continuous annealed or non-annealed carbon-containing shell (18).

11. Electrical energy storage device (22) according to claim 10, characterized in that said third carbon-containing shell (18) has a maximum average thickness of 500 nm.

12. Method for producing particles (10, 20, 30, 40) comprising an amorphous or crystalline silicon-based core (12) for an anode (24) of an electrical energy storage device (22), characterized in that the method comprises the steps of:
coating silicon-based core particles (12) with a first carbon-containing material and then
coating said particles comprising a silicon-based core (12) and said first carbon-containing shell with a second carbon-containing material, thereby creating a first carbon-containing shell (14) and second carbon-containing shell (16), whereby said second carbon-containing shell (16) has a higher density than said first carbon-containing shell (14) and/or a higher atomic percentage of carbon than said first carbon-containing shell (14).

13. Method according to claim 12, characterized in that it comprises the step of annealing said coated particles to thereby create an annealed first carbon-containing shell (14a) and an annealed second carbon-containing shell (16a).

14. Method according to claim 13, characterized in that said step of creating a first annealed carbon-containing shell (14a) and a second annealed carbon-containing shell (16a) comprises annealing said particles comprising a silicon-based core (12), a first carbon-containing shell (14) and a second carbon-containing shell (16) by heating them to a temperature of 500-1500° C. in an oxygen-free atmosphere to produce an annealed first carbon-containing shell (14a) and an annealed second first carbon-containing shell (16a).

15. Method according to any of claims 12-14, characterized in that said first carbon-containing shell (14, 14a) and/or said second carbon-containing shell (16, 16a) comprises at least one of the following: a synthetic or natural polymer or copolymer (linear, branched or cross-linked), such as a saturated and unsaturated hydrocarbon-based polymer (such as polyethylene and similar), a polymer based on a carbohydrate material, a sugar-based polymer, an aromatic hydrocarbon polymer (such as substituted or non-substituted polystyrene), an aromatic residue from petroleum, a chemical process pitch, a lignin-based polymer, a phenolic-based polymer (products of condensation of substituted or non-substituted phenols with carbonyl compounds, such phenol-formaldehyde), methacrylate-based polymers (such as polymethyl methacrylate or its analogues), polyethers, polyesters, halogen-containing polymers (such as polyvinyl chloride) or a polymer containing one or more heteroatoms, nitrogen (N), oxygen (O) or phosphorus (P), such as polyacrylonitrile or a combination of thereof.

16. Method according to any of claims 12-15, characterized in that said first carbon-containing material and/or said second carbon-containing material is/are applied using a solution-based technique.

17. Method according to claim 16, characterized in that said solution-based technique comprises mixing said silicon-based core particles (12) with a solution of said first carbon-containing material and/or mixing said particles comprising a silicon-based core (12) and said first carbon-containing shell with a solution of said second carbon-containing material.

18. Method according to any of claims 12-15, characterized in that said first carbon-containing material and/or said second carbon-containing material is/are applied by performing polymerization in the presence of said silicon-based core particles (12) or said particles comprising a silicon-based core (12) and said first carbon-containing shell, respectively.

19. Method according to any of any of claims 12-18, characterized in that said first carbon-containing material and/or said second carbon-containing material is/are applied to the entire surface area of said silicon-based core particles (12) and/or to the entire surface area of said particles comprising a silicon-based core (12) and said first carbon-containing shell respectively, whereby said first carbon-containing shell and/or said second carbon-containing shell provides continuous coverage of the particles' surface.

20. Method according to any of claims 12-18, characterized in that said first carbon-containing material and/or said second carbon-containing material is/are applied to one or more parts of a surface area of said silicon-based core particles (12) and/or to at least one part of a surface area of said particles comprising a silicon-based core (12) and said first carbon-containing shell respectively, whereby said first carbon-containing shell and/or said second carbon-containing shell provides non-continuous coverage of the particles' surface.

21. Method according to any of claims 12-20, characterized in that said silicon-based core particles (12) comprise one of the following: pure silicon or silicon containing one or more other elements, modified or non-modified, stoichiometric or non-stochiometric silicon nitride or silicon carbide or silicon oxide, a material comprising at least 20 atomic-% silicon.

22. Method according to any of claims 12-21, characterized in that said silicon-based core particles (12) comprise aggregated silicon-based core particles (12).

23. Method according to any of claims 12-22, characterized in that said first carbon-containing shell (14, 14a) and said second carbon-containing shell (16, 16a) each have a maximum thickness of up to 100 nm.

24. Method according to any of claims 13-20, characterized in that it comprises the step of coating particles comprising a silicon-based core (12), a first carbon-containing shell and a second carbon-containing shell, with one or more additional continuous or non-continuous shells before annealing.

25. Method according to any of claims 12-24, characterized in that said particles (10, 20, 30, 40) comprising a silicon-based core having a diameter of 20 nm-2 μm for spherical particles, or a minimum transverse dimension of 20 nm-2 μm for non-spherical particles.

26. Method according to any of claims 12-25, characterized in that it comprises the step of embedding said particles (10, 20, 30, 40) in one of the following: graphite, an organic or inorganic polymeric material.
